(19) United States
(12) Patent Application Publication
(10) Pub. No.: US 2004/0051714 A1
(43) Pub. Date: Mar. 18, 2004

(54) Graphics display module and method

(76) Inventors: Ira Liao, Hsinchu (TW); Titan Sun, Hsinchu (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/647,805

(22) Filed: Aug. 25, 2003

(30) Foreign Application Priority Data
Sep. 18, 2002 (TW) 091121316

(51) Int. Cl. G06T 9/00

(52) U.S. Cl. 345/555

(57) ABSTRACT

A graphics display module for use with an image pickup device, an image data storage unit and an image display device in a computer system includes a data compressing device and a data decompressing device. The data compressing device is in communication with the image pickup device, and compresses a digital image data received from the image pickup device into a compressed image data that is then transmitted to the image data storage unit for storage. The data decompressing device is in communication with the image data storage unit and the image displaying device, and decompresses the compressed image data stored in the image data storage unit to recover the digital image data that is then transmitted to the image displaying device for display.

### FIELD OF THE INVENTION

The present invention relates to a graphics display module, and more particularly to a graphics display module for use in a computer system. The present invention also relates to a graphics display method.

### BACKGROUND OF THE INVENTION

In a conventional computer system of FIG. 1, a north bridge chip 11 and a south bridge chip 12 are used to control data flows among a microprocessor 10, a system memory 13, and a plurality of I/O devices including a graphics card 14. The microprocessor 10 accesses graphics data of the system memory 13 or outputs graphing commands to the graphics card 14 via the north bridge chip 11. The system memory 13 is usually a dynamic random access memory (DRAM). The graphics card 14 is electrically connected to the north bridge chip 11 via a PCI (Peripheral Component Interconnect) or AGP (Accelerated Graphics Port) bus, and comprises a graphics chip 141, a local memory 142 and an analog-to-digital (A/D) converter 143. The local memory 142 of the graphics card 14 is usually used as a frame buffer. Furthermore, the AGP memory 131 of the system memory 13 can be accessed by the graphics chip 141 in a directly access mode, and used as a texture buffer.

Nowadays, many electrical appliances are widely used with computers due to the amazing power of computers. So far, the image source processed by a computer system includes, for example, a TV tuner 15. The analog signals from the TV tuner 15 are firstly transmitted to the graphics card 14 and converted into digital signals by the analog-to-digital converter 143. Then, the digital signals are transmitted to the graphics chip 141 to be processed. The processed image signals are written in the frame buffer of the local memory 142, and then read out to be displayed. On the other hand, the digital image signals are written in the AGP memory 131 of the system memory 13 in a direct memory access (DMA) mode. The digital image signals stored in the AGP memory 131 of the system memory 13 are further converted into a file and stored in a non-volatile memory device such as a hard disc 16.

Since the amount of image data are huge, large memory space, memory bandwidth, bandwidth of the PCI (Peripheral Component Interconnect) or AGP (Accelerated Graphics Port) bus and even storage space of the non-volatile memory device are required for pickup and display of the image data. Therefore, the tremendous image data transmission might reduce the overall performance of the computer system.

### SUMMARY OF THE INVENTION

It is an object of the present invention to provide a graphics display method for use in a computer system, which reduces image data amount in transmission, so as to enhance performance of the computer system.

Another object of the present invention is to provide a graphics display module, which processes the image data before the image data are transmitted, so as to reduce image data amount in transmission.

In accordance with a first aspect of the present invention, there is provided a graphics display module for use with an image pickup device, an image data storage unit and an image display device in a computer system. The graphics display module comprises a data compressing device and a data decompressing device. The data compressing device is in communication with the image pickup device, and compresses a digital image data received from the image pickup device into a compressed image data that is then transmitted to the image data storage unit for storage. The data decompressing device is in communication with the image data storage unit and the image displaying device, and decompresses the compressed image data stored in the image data storage unit to recover the digital image data that is then transmitted to the image displaying device for display.

In an embodiment, the data compressing device and the data decompressing device are integrated into a graphics chip.

In an embodiment, the graphics chip is disposed in a graphics card.

In an embodiment, the image data storage unit is a frame buffer defined in a local memory of the graphics card.

In an embodiment, the image data storage unit is in communication with a system memory of the computer system, and further transmits the compressed image data to the system memory in a DMA mode.

In an embodiment, the graphics chip is disposed in a north-bridge chip of the computer system.

In an embodiment, the image data storage unit is a specified memory block defined in a system memory of the computer system. Specifically, the specified memory block in the system memory is an AGP memory.

In an embodiment, the image pickup device and the image display device are disposed in the graphics card along with the graphics chip.

In an embodiment, the image pickup device is a TV decoder outputting the digital image signal in response to an NTSC or a PAL analog signal.

In accordance with a second aspect of the present invention, there is provided a computer system comprises a core logic unit, a system memory, an image pickup device, a data compressing device, an image data storage unit, a data decompressing device and an image display device. The system memory is accessible by the core logic unit. The image pickup device receives and converts an analog image signal into a digital image data. The data compressing device is in communication with the image pickup device, and compresses the digital image data into a compressed image data. The image data storage unit is in communication with the data compressing device for storing therein the compressed image data. The data decompressing device is in communication with the image data storage unit, and decompresses the compressed image data stored in the image data storage unit to recover the digital image data. The image display device is in communication with the data decompressing device, receives and displays the digital image data.

In an embodiment, the data compressing device and the data decompressing device are integrated in a graphics chip. Specifically, the graphics chip is disposed in a graphics card in communication with the core logic unit. More specifically, the graphics chip is integrated with the core logic unit.

In accordance with a third aspect of the present invention, there is provided a graphics display method for use in a computer system. The computer system comprises an image pickup device, an image data storage unit and an image display device. The graphics display method comprises the following steps. Firstly, a digital image data received from the image pickup device is compressed into a compressed image data. Then, the compressed image data are stored into the image data storage unit. Afterwards, the compressed image data are decompressed to recover the digital image data before the digital image data are to be played by the image display device.

In an embodiment, the compressing and decompressing steps are performed by a graphics card.

In an embodiment, the compressing and decompressing steps are performed by a north-bridge chip.

In an embodiment, the image data storage unit where the compressed image data are stored is a specified memory block of a system memory.

In an embodiment, the image data storage unit where the compressed image data are stored is a frame buffer of a local memory.

In an embodiment, the graphics display method further comprises a step of transmitting the compressed image data to a system memory in a DMA mode.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a block diagram showing the structure of a conventional computer system;

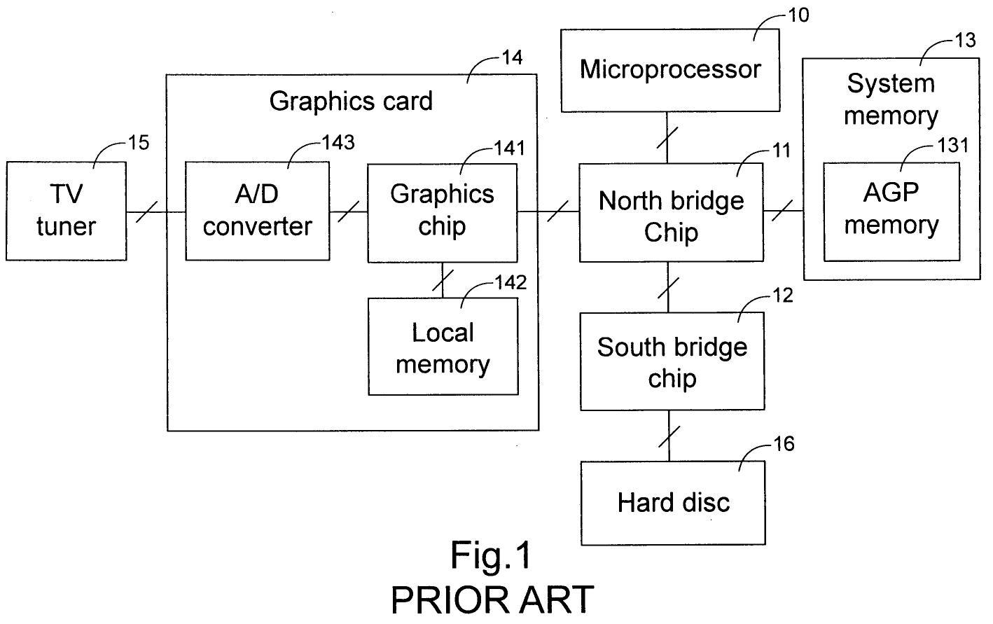

FIG. 2 is a block diagram showing a graphic display module for use in a computer system according to a preferred embodiment of the present invention; and

FIG. 3 is a block diagram showing a graphic display module for use in a computer system according to another preferred embodiment of the present invention.

### DETAILED DESCRIPTION OF THE PREFERRED EMBODIMENT

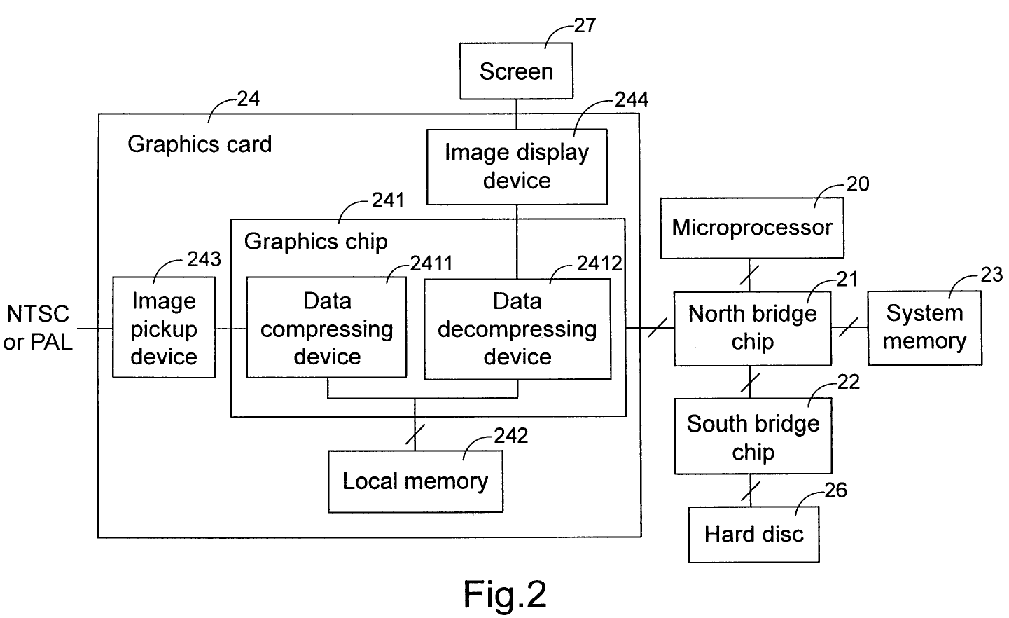

Referring to FIG. 2, a computer system comprising therein the graphics display module according to a preferred embodiment of the present invention comprises a microprocessor 20, a north bridge chip 21, a south bridge chip 22, a system memory 23 and a graphics card 24. The north bridge chip 21 and the south bridge chip 22 control data flows among the microprocessor 20, the system memory 23, and a plurality of I/O devices including the graphics card 24. The graphics card 24 is electrically connected to the north bridge chip 21 via a PCI (Peripheral Component Interconnect) or AGP (Accelerated Graphics Port) bus, and comprises a graphics chip 241, a local memory 242, an image pickup device 243 and an image display device 244. A data compressing device 2411 and a data decompressing device 2412 are incorporated into the graphics chip 241. The image pickup device 243, for example a TV signal decoder, is employed to convert analog image data (for example in an NTSC or a PAL format) into digital image data (for example in a YUV422 format), and the digital image data are then transmitted to the graphics chip 241 of the graphics card 24. The digital image data are compressed into compressed image data and stored in the frame buffer defined in the local memory 242. When the compressed image data are to be stored as an image file, the compressed image data can be written into the system memory 23 in a direct memory access (DMA) mode and then transferred to the hard disc 26.

When the image file is ready for display, the image file is firstly transmitted from the hard disc 26 to the system memory 23, and then the compressed image data are moved into the frame buffer of the local memory 242 in a DMA mode. The image file is then decompressed by the data decompressing device 2412 and recovered into the original digital image data, which are then transmitted to the image display device 244 to be displayed on a screen 27.

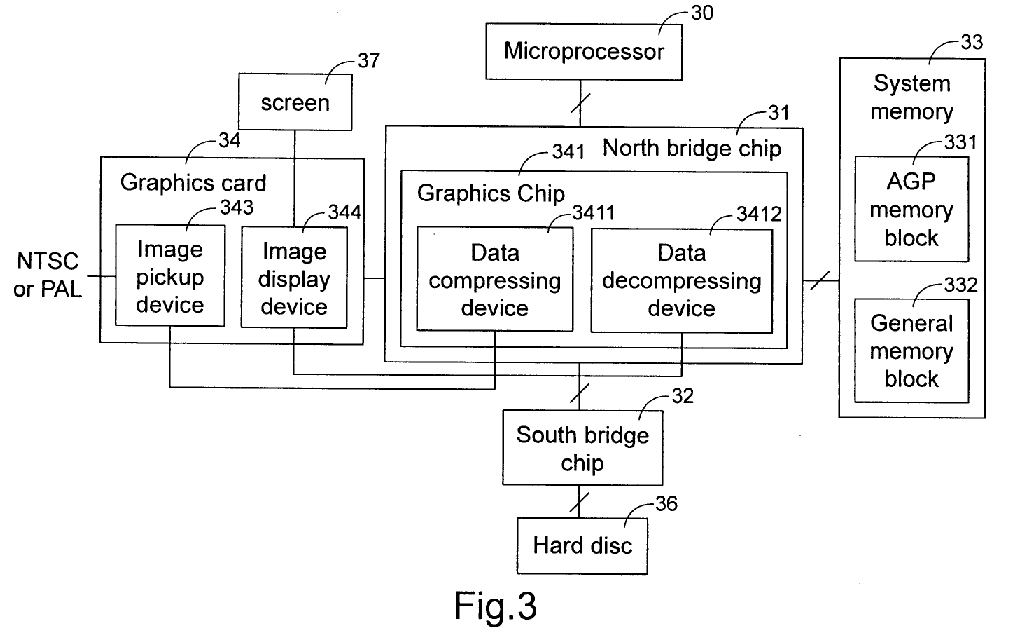

Referring to FIG. 3, a further embodiment of a graphics display module for use in a personal computer system according to the present invention is shown. The personal computer system comprises a microprocessor 30, a north bridge chip 31, a south bridge chip 32, a system memory 33 and a graphics card 34. The north bridge chip 31 and the south bridge chip 32 control data flows among the microprocessor 30, the system memory 33, and a plurality of I/O devices including the graphics card 34. The graphics card 34 is electrically connected to the north bridge chip 31 via a PCI (Peripheral Component Interconnect) or AGP (Accelerated Graphics Port) bus, and comprises an image pickup device 343 and an image display device 344. The image pickup device 343, for example a TV signal decoder, is employed to convert analog image data (for example in an NTSC or a PAL format) into digital image data (for example in a YUV422 format). The digital image data are then transmitted to a graphics chip 341 integrated into the north bridge chip 31. A data compressing device 3411 and a data decompressing device 3412 are incorporated in the graphics chip 341. The digital image data, transmitted from the image pickup device 343 are compressed into compressed image data by the data compressing device 3411 and stored in a frame buffer defined in an AGP (Accelerated Graphics Port) memory block 331 of the system memory 33. When the compressed image data are to be stored as an image file, the compressed image data are written into a general memory block 332 in the system memory 33 in a DMA mode and then transferred to the hard disc 36.

When the image file is ready for display, the image file is firstly transmitted from the hard disc 36 to the system memory 33, and then the compressed image data are moved into the frame buffer. The image file is then decompressed by the data decompressing device 3412 and recovered into the original digital image data, which are then transmitted to the image display device 344 to be displayed on a screen 37.

Since the image data are compressed in advance, the data to be transmitted will be effectively minimized during the image pickup and display operations. Therefore, memory space, memory bandwidth, bandwidth of the PCI or the AGP bus and even storage space of the non-volatile memory device can be largely saved so as to enhance the overall performance of the computer system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A graphics display module for use with an image pickup device, a system memory and an image display device in a computer system, comprising:
a data compressing device in communication with said image pickup device, compressing a digital image data received from said image pickup device into a compressed image data;
an image data storage unit in communication with said compressing device and said system memory for storing said compressed image data, said compressed image data being transmitted to said system memory in a DMA mode; and
a data decompressing device in communication with said image data storage unit and said image displaying device, decompressing said compressed image data stored in said image data storage unit to recover said digital image data that is then transmitted to said image displaying device for display.

2. The graphics display module according to claim 1 wherein said data compressing device and said data decompressing device are integrated into a graphics chip.

3. The graphics display module according to claim 2 wherein said graphics chip is disposed in a graphics card.

4. The graphics display module according to claim 3 wherein said image data storage unit is a frame buffer defined in a local memory of said graphics card.

5. A graphics display module for use with an image pickup device, a system memory and an image display device in a computer system, comprising:
a data compressing device in communication with said image pickup device, compressing a digital image data received from said image pickup device into a compressed image data;
an image data storage unit in communication with said compressing device, disposed in said system memory for storing said compressed image data; and
a data decompressing device in communication with said image data storage unit and said image displaying device, decompressing said compressed image data stored in said image data storage unit to recover said digital image data that is then transmitted to said image displaying device for display.

6. The graphics display module according to claim 5 wherein said data compressing device and said data decompressing device are integrated into a graphics chip that is disposed in a north-bridge chip of said computer system.

7. The graphics display module according to claim 6 wherein said image data storage unit is an AGP memory defined in said system memory of said computer system.

8. A computer system, comprising:
a core logic unit;
a system memory accessible by said core logic unit;
an image pickup device receiving and converting an analog image signal into a digital image data;
a data compressing device in communication with said image pickup device, compressing said digital image data into a compressed image data;
an image data storage unit in communication with said data compressing device for storing therein said compressed image data;
a data decompressing device in communication with said image data storage unit, decompressing said compressed image data stored in said image data storage unit to recover said digital image data; and
an image display device in communication with said data decompressing device, receiving and displaying said digital image data.

9. The computer system according to claim 8 wherein said data compressing device and said data decompressing device are integrated in a graphics chip.

10. The computer system according to claim 9 wherein said graphics chip is disposed in a graphics card in communication with said core logic unit.

11. The computer system according to claim 10 wherein said image data storage unit is a frame buffer defined in a local memory of said graphics card.

12. The computer system according to claim 9 wherein said graphics chip is integrated with said core logic unit.

13. The computer system according to claim 12 wherein said core logic unit is a north-bridge chip.

14. The graphics display module according to claim 8 wherein said image data storage unit is a specified memory block defined in said system memory.

15. The computer system according to claim 8 wherein said image pickup device and said image display device are disposed in a graphics card.

16. A graphics display method for use in a computer system, said computer system comprising an image pickup device, an image data storage unit and an image display device, and said method comprising steps of:
compressing a digital image data received from said image pickup device into a compressed image data;
storing said compressed image data into said image data storage unit; and
decompressing said compressed image data to recover said digital image data before said digital image data are to be played by said image display device.

17. The method according to claim 16 wherein said compressing and decompressing steps are performed by a graphics card.

18. The method according to claim 16 wherein said compressing and decompressing steps are performed by a north-bridge chip.

19. The method according to claim 16 wherein said image data storage unit where said compressed image data are stored is a specified memory block of a system memory.

20. The method according to claim 16 wherein said image data storage unit where said compressed image data are stored is a frame buffer of a local memory.

21. The method according to claim 20 further comprising a step of transmitting said compressed image data to a system memory in a DMA mode.
